(19) United States
(12) Patent Application Publication
(10) Pub. No.: US 2023/0363331 A1
(43) Pub. Date: Nov. 16, 2023

(54) COMPOSITIONS AND METHODS FOR IMPROVING FLOWABILITY OF SUPERABSORBENT POLYMERS

(71) Applicant: Kannar Earth Science, Ltd., Lawrenceville, GA (US)

(72) Inventors: Samuel L. Cloete, Suwanee, GA (US); Heather Lewis, Duluth, GA (US)

(21) Appl. No.: 18/356,625

(22) Filed: Jul. 21, 2023

Related U.S. Application Data
(63) Continuation of application No. PCT/US22/14734, filed on Feb. 1, 2022.
(60) Provisional application No. 63/144,137, filed on Feb. 1, 2021.

(51) Int. Cl. A01G 24/35; A01C 1/06; B01J 20/26; B01J 20/24

(52) U.S. Cl. CPC A01G 24/35; A01C 1/06; B01J 20/262; B01J 20/24; B01J 2220/68; B01J 2220/44; B01J 2220/4825; B01J 2220/485

(57) ABSTRACT

A method includes mixing a dry hydrophobic material with a dry superabsorbent polymer to improve the flowability of the polymer in humid conditions within a machine passageway having a residency time. The application of superabsorbent polymers in agriculture is desirable to aid plant growth in increasingly hot and dry conditions. However, dry bulk planting applications typically used in agriculture require the dry amendment to pass through confined channels and narrow pores. This is problematic because the polymers rapidly absorb moisture from the environment and adhere to the planting equipment causing fouling and clogging. The improvement in flowability provided by the compositions disclosed herein, is to the extent that the superabsorbent starch-like polymer can be applied using dry bulk planting applications in the humid conditions of Florida in the springtime. Surprisingly, the dry mixtures improve flowability without undermining the ability of the polymers to rapidly absorb moisture from rain.

This application is a continuation of PCT Patent Application No. PCT/US2022/014734 filed on Feb. 1, 2022, which claims priority to U.S. Provisional Patent Application No. 63/144,137 filed on Feb. 1, 2021, the entire contents of all of which are incorporated by reference herein.

### TECHNICAL FIELD

The present invention is related to mixtures of dry hydrophobic materials with dry superabsorbent polymers to improve the flowability of the superabsorbent polymers in dry bulk planting applications in agriculture.

### BACKGROUND

With the advent of increasing temperatures and dry and drought-like conditions, there is a need to improve the water retention ability of soils to sustain plant crops. Superabsorbent polymers such as the starch-based product ZEBA sold by UPL NA Inc. have been used as soil conditioners and seed coatings to keep a constant supply of moisture available to germinating seed, seedlings, and plants throughout the growing season. These polymers act like a sponge and can absorb more than 400 times their original weight in water, forming hydrogels that slowly release moisture back to plants as they need it.

Unfortunately, a limitation of the super water absorbing properties of these polymers is that they rapidly absorb water in humid conditions, which frequently results in fouling and clogging of the confined channels and narrow openings in equipment used in the dry bulk application processes of modern agriculture. The issues have severely limited the usefulness of these products in agriculture.

Thus, an unmet need remains for compositions and methods to improve the flowability of superabsorbent polymers used in dry bulk planting applications. The present disclosure provides such compositions and methods.

### SUMMARY

In one aspect, a method is provided for improving the flowability of dry superabsorbent polymers for use in dry bulk applications in agriculture. The method includes mixing a dry superabsorbent polymer with a dry hydrophobic material, which surprisingly improves the flowability of the dry superabsorbent polymer in humid environments, without undermining the efficacy of the polymer in the soil. After being applied to soil as a dry mixture, the superabsorbent polymer is still able to rapidly absorb moisture from rain.

In one aspect, a dry composition is provided for improving the flowability of dry superabsorbent polymers, in particular, for use in dry bulk applications in agriculture. The dry composition comprises a mixture of a superabsorbent polymer and a hydrophobic material. Examples of the superabsorbent polymer include, but are not limited to, starch-based polymers, starch-g-poly (2-propenamide-co-2-propenoic acid), xanthan gum, guar gum, hydroxyethylcarboxymethylcellulose, carboxymethylcellulose, polyacrylamides, and derivatives and combinations thereof. Examples of the hydrophobic material include, but are not limited to, i) combinations of protein powder and lipid, ii) micronized powders, iii) micronized waxes, iv) fumed silica, v) treated clay particles, and combinations thereof.

Other superabsorbent polymers may be used. Additionally, other compounds or materials such as Zeolite hyaluronic acid, (humic acid, Chitin/chitosan polymers, volcanic earth and ash, kelp and sea weed powders, etc. may be used for similar purposes mentioned in this invention.

### BRIEF DESCRIPTION OF THE DRAWINGS

FIG. 1 illustrates auguring of a dry composition of the present disclosure from a hopper box through a confined channel delivery tube in an experiment conducted under very humid conditions in the springtime in which the dry composition was applied to the roots of pine seedlings at planting.

FIG. 2 illustrates the dry composition present a hopper box in the experiment of FIG. 1.

FIG. 3 illustrates the dry composition being applied to a newly trenched furrow in the experiment of FIG. 1 and showing that the composition has not picked up significant moisture.

FIG. 4 illustrates the dry composition being applied in a furrow in the experiment of FIG. 1.

FIG. 5 illustrates a flowchart depicting one or more methods disclosed herein.

FIG. 6 illustrates exemplary imagery of the combined mixture according to one or more embodiments disclosed herein.

### DETAILED DESCRIPTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Following long-standing patent law convention, the terms “a,” “an,” and “the” refer to “one or more” when used in this application, including the claims. Thus, for example, reference to “a dry composition” includes a plurality of dry compositions, unless the context clearly is to the contrary, and so forth.

Throughout this specification and the claims, the terms “comprise,” “comprises,” and “comprising” are used in a non-exclusive sense, except where the context requires otherwise. Likewise, the terms “having” and “including” and their grammatical variants are intended to be non-limiting, such that recitation of items in a list is not to the exclusion of other like items that can be substituted or added to the listed items.

The present disclosure provides dry compositions and methods for improving the flowability of superabsorbent polymers in dry bulk planting applications in agriculture in both dry and very humid conditions. For example, dry amendments applied in agriculture are frequently placed in the seed furrow or in similar applications to the soil. These types of applications to the soil often involve the use of metering boxes, hopper boxes, delivery tubes, spray tubes, pneumatic distributors, air spreaders, air booms, air attachments, and the like, which require the dry amendment being applied to pass through confined channels and narrow pores. Such dry bulk application is often problematic because the superabsorbent polymers rapidly absorb moisture from the environment and adhere to the planting equipment causing fouling and clogging. The compositions and methods of the present disclosure can enhance the plantability and application of super water or moisture holding dry materials in agriculture.

Disclosed herein is an unexpected discovery that certain hydrophobic materials when mixed with superabsorbent polymers, such as starch-based product ZEBA, can drastically improve flowability through dry bulk application systems even in high humidity environments. The surprising effect of the mixture was the inhibition of moisture retention by the superabsorbent polymer. The mixture did more than was expected. For example, it was initially thought the combination would just cause the superabsorbent polymer to flow a bit faster, but still end up sticking to equipment upon exposure to moisture. The unexpected finding was that after mixing with the hydrophobic materials, the superabsorbent polymer was capable of being metered and dosed into soil by way of dry bulk handling equipment under humid planting conditions without undermining the efficacy of the polymer in the soil. After being applied to the soil as a dry mixture, the superabsorbent polymer was still able to rapidly absorb moisture following the first rain.

Other superabsorbent polymers may be used. Additionally, other compounds or materials such as Zeolite hyaluronic acid, (humic acid, Chitin/chitosan polymers, volcanic earth and ash, kelp and sea weed powders, etc. may be used for similar purposes mentioned in this invention.

A specific example of the dry compositions and methods disclosed herein for improving the flowability of superabsorbent polymers is described in the experiment in Example 1. The experiment was undertaken to determine whether a hydrophobic material could be combined with a superabsorbent polymer starch-g-poly (2-propenamide-co-2-propenoic acid) sold as “ZEBA” by UPL NA Inc to allow its use in dry bulk handling equipment under humid planting conditions in the springtime in Florida. Typically, this would not be possible with SUPERABSORBENT POLYMER, as the superabsorbent polymer product would adhere to the planting equipment in the humid conditions causing fouling and clogging and preventing application.

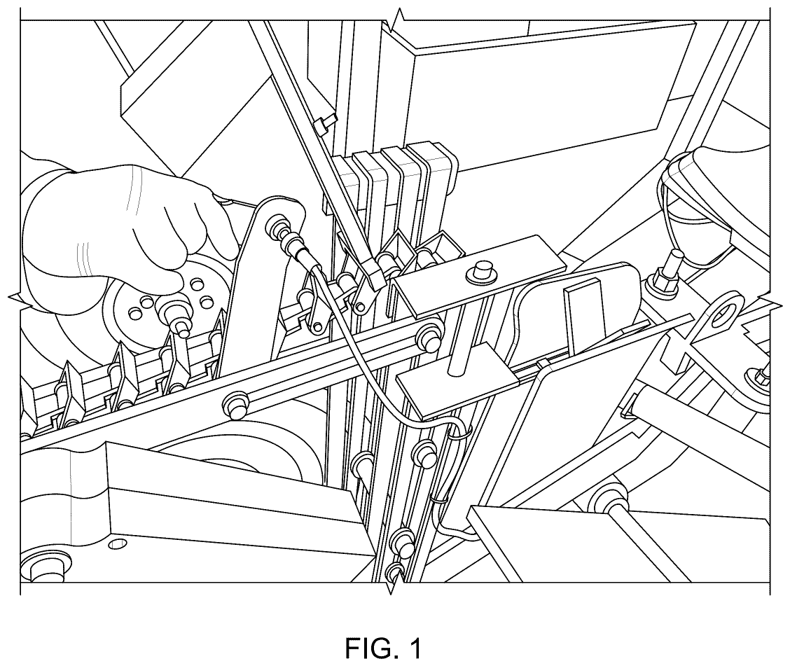

In the experiment, the dry hydrophobic material was the product “DUST” sold by the company Low Mu Tech. DUST was mixed at a ratio of 1 part DUST with 30 parts superabsorbent polymer. DUST is a formulation of protein powder and lipid that is marketed for improving seed flowability. The photographs in FIGS. 1-4 illustrate the dry bulk handling equipment that was used under the very humid planting conditions. The combination of hydrophobic material and superabsorbent polymer resulted in a dry mixture that was resistant to picking up moisture during the planting process and did not adhere to, clog, or foul the planting equipment. Without being limited to any one mechanism of action, the mixture can result in mitigating both static cling and product bridging from the superabsorbent polymer product, thus improving the ability of the product to flow to through confined channels and narrow openings in dry to very humid environments.

The superabsorbent polymers of the present disclosure include, but are not limited to, starch-based polymers, starch-g-poly (2-propenamide-co-2-propenoic acid), xanthan gum, guar gum, hydroxyethylcarboxymethylcellulose, carboxymethylcellulose, polyacrylamides, and derivatives and combinations thereof.

Other superabsorbent polymers may be used. Additionally, other compounds or materials such as Zeolite hyaluronic acid, (humic acid, Chitin/chitosan polymers, volcanic earth and ash, kelp and sea weed powders, etc. may be used for similar purposes mentioned in this invention.

The hydrophobic materials of the present disclosure include flow aid compositions such as, but not limited to, compositions comprising a protein powder and a lipid, micronized powders, micronized waxes, fumed silica, and treated clay particles.

The compositions of the present disclosure comprising a protein powder and a lipid include: a protein powder including, but not limited to, a soy protein powder, a corn protein powder, an oat protein powder, a wheat protein powder, a pea protein powder, a rice protein powder, a nut protein powder, an algal protein powder, a kelp protein powder, a whey protein powder, a casein protein powder, an egg protein powder, an albumen protein powder, a blood meal protein powder, a bone meal protein powder, a fish protein powder, a shellfish protein powder, a plankton protein powder, a yeast protein powder, a bacterial protein powder, or a combination thereof; and a lipid including, but not limited to, a lecithin, a soy lecithin, a vegetable oil, a fish oil, an animal fat, or a combination thereof.

The micronized powders and micronized waxes of the present disclosure include, but are not limited to, bran wax, Oryza sativa bran wax, carnauba wax and aluminum oxide, poly(hydroxybutyrate-co-hydroxyvalerate), and combinations thereof.

In one aspect of the present disclosure, a dry composition is provided for improving the flowability of superabsorbent polymers, the composition comprising a mixture of a dry superabsorbent polymer of the present disclosure and a dry hydrophobic material of the present disclosure. The dry composition can be stored in dry conditions free from moisture.

In one aspect, a dry composition is provided for improving the flowability of superabsorbent polymers, the dry composition comprising a mixture of a dry superabsorbent polymer and a dry hydrophobic material at a weight ratio of the superabsorbent polymer to the hydrophobic material ranging from 100:1 to 1:1000.

In one aspect, a dry composition is provided comprising a mixture of a dry superabsorbent polymer and a dry hydrophobic material at a weight ratio of the superabsorbent polymer to the hydrophobic material ranging from 1:50 to 1:200.

In one aspect, a method is provided for improving the flowability of a dry composition of a superabsorbent polymer in an agricultural environment. As an example, the environment may be in a planting scenario where the superabsorbent polymer is being added to a furrow or other planting site in order to provide concentrated moisture for seed germination. The method may include mixing a dry superabsorbent polymer of the present disclosure with a dry hydrophobic material of the present disclosure. The dry hydrophobic material can include i) a protein powder and a lipid, ii) a micronized powder, iii) a micronized wax, iv) fumed silica, v) treated clay particles and combinations thereof.

Accordingly, while the methods and systems have been described in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

### EXAMPLES

### Example 1

### Improved Flowability of ZEBA Using Dry Bulk Application During High Humidity Periods

An experiment was performed to test whether the combination of the product hydrophobic material (Low Mu Tech) with the product ZEBA (UPL NA Inc) would improve the flowability of superabsorbent polymer in the dry bulk application equipment under very humid conditions.

The superabsorbent polymer is made up of superabsorbent polymer starch-g-poly (2-propenamide-co-2-propenoic acid and hydrophobic material contains a combination of a soy protein and soy lipid. The two dry powder compositions were mixed at a ratio of 30:1 superabsorbent polymer (in this instance ZEBA) to hydrophobic material and this mixture was used in the planting experiment. The images in FIGS. 1-4 illustrate the dry bulk handling equipment that was used to apply the mixture under very humid planting conditions.

The results were unexpected. The addition of hydrophobic material prevented the superabsorbent polymer from attracting moisture. It was initially thought that the superabsorbent polymer would simply flow a bit faster, but still end up sticking to equipment due to its reaction when exposed to moisture. Instead, the surprising discovery was that the combined mixture was now capable of being metered and dosed into soil by way of dry bulk handling equipment, even in the humid planting conditions. An improved ability to flow to through confined channels and narrow openings was observed for the superabsorbent polymer-hydrophobic material mixture in the very humid environment. Without being limited to any one mechanism of action, both static cling and product bridging were mitigated or eliminated in the superabsorbent polymer mixture. An additional surprising result was that the efficacy of the superabsorbent polymer was not undermined in the soil. The superabsorbent polymer-hydrophobic material mixture was still able to rapidly absorb moisture following the first rain.

FIG. 1 illustrates auguring of dry superabsorbent polymer mixture from a hopper box through a confined channel delivery tube in an experiment conducted in Florida under very humid conditions in the springtime in which the dry mixture was applied to the roots of pine seedlings at planting.

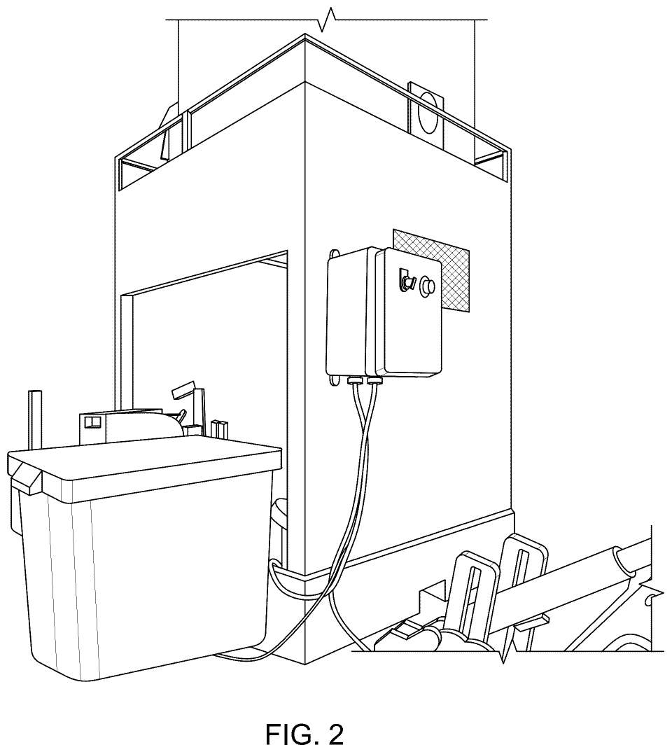

FIG. 2 illustrates the dry superabsorbent polymer mixture present a hopper box in an experiment conducted in Florida under very humid conditions in the springtime.

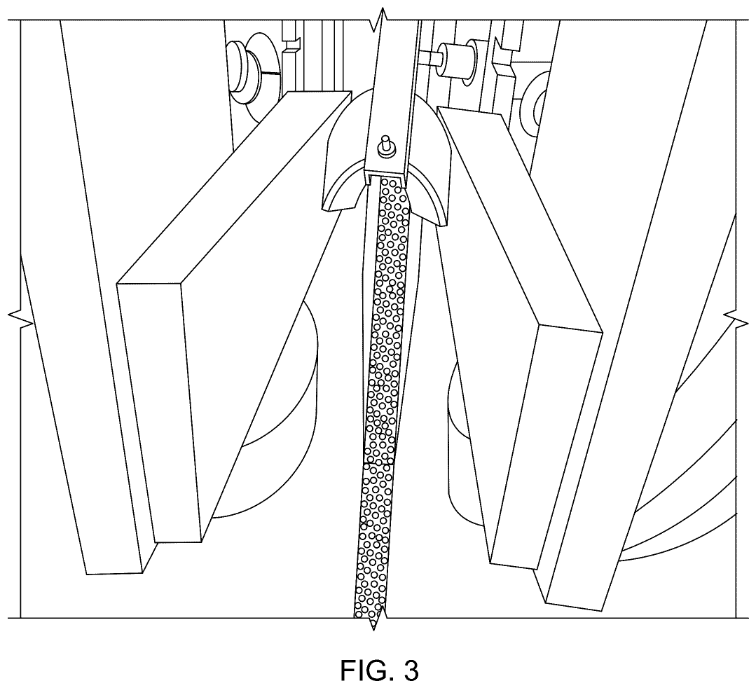

FIG. 3 illustrates the dry superabsorbent polymer-hydrophobic material mixture being applied to a newly trenched furrow in an experiment conducted in Florida under very humid conditions in the springtime and showing that the mixture has not picked up significant moisture.

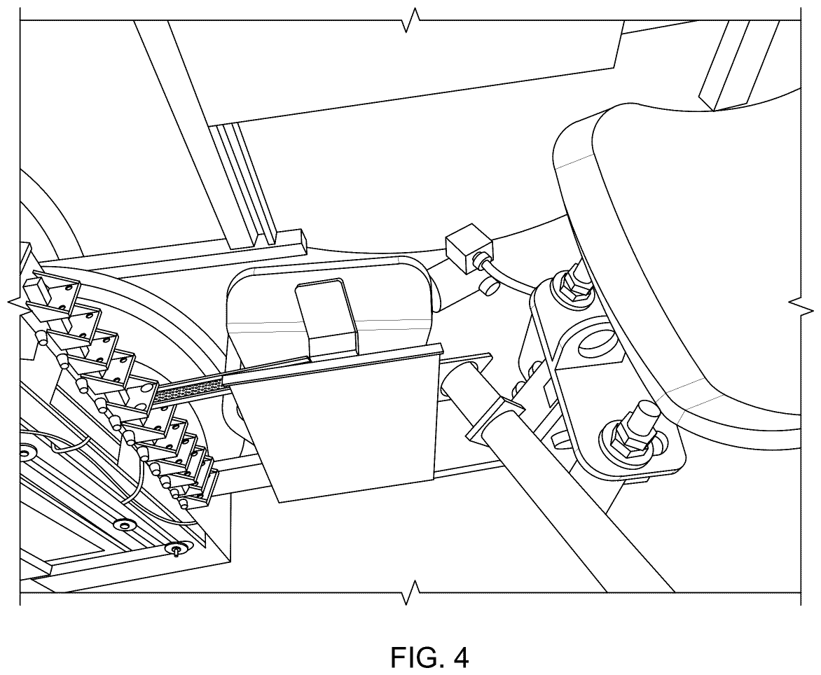

FIG. 4 illustrates the dry superabsorbent polymer-hydrophobic material mixture being applied in a furrow in an experiment conducted in Florida under very humid conditions in the springtime.

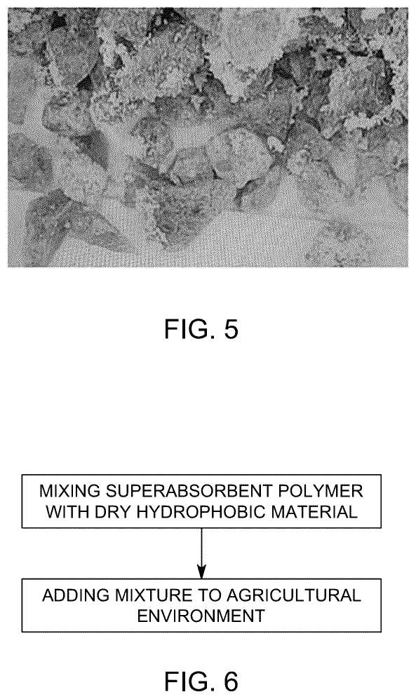

FIG. 5 illustrates one example of a mixed concentration and construction of the superabsorbent and hydrophobic material. The mixture may be made from a method generally illustrated through the flow chart in FIG. 6.

The method may include improving the flowability of a dry superabsorbent polymer for use in an agricultural environment. The agricultural environment may be within a machine at site application where the materials are mixed immediately before residency in the machine for application to a trench or furrow site. The environment may also be somewhere external to the planting site, where the materials are pre-mixed for sale or use by a farming entity. The materials may also be mixed with seed, or other nutrients or additives.

The method may include mixing a dry superabsorbent polymer with a dry hydrophobic material. In experimentation, the mixing improves the flowability of the dry superabsorbent polymer.

In one or more embodiments, the superabsorbent polymer includes one or a combination of starch-based polymers, starch-g-poly (2-propenamide-co-2-propenoic acid), xanthan gum, guar gum, hydroxyethylcarboxymethylcellulose, carboxymethylcellulose, polyacrylamides, and derivatives thereof.

Other superabsorbent polymers may be used. Additionally, other compounds or materials such as Zeolite hyaluronic acid, (humic acid, Chitin/chitosan polymers, volcanic earth and ash, kelp and sea weed powders, etc. may be used for similar purposes mentioned in this invention.

In one or more embodiments, the hydrophobic material includes: i) a protein powder and a lipid, ii) a micronized powder, iii) a micronized wax, iv) fumed silica, or v) treated clay particles, and combinations thereof.

In one or more embodiments, the protein powder and the lipid include one or a combination of a soy protein powder, a corn protein powder, an oat protein powder, a wheat protein powder, a pea protein powder, a rice protein powder, a nut protein powder, an algal protein powder, a kelp protein powder, a whey protein powder, a casein protein powder, an egg protein powder, an albumen protein powder, a blood meal protein powder, a bone meal protein powder, a fish protein powder, a shellfish protein powder, a plankton protein powder, a yeast protein powder, a bacterial protein powder, a lecithin, a soy lecithin, a vegetable oil, a fish oil, and an animal fat.

In one or more embodiments, wherein the micronized powder or micronized wax comprises one or a combination of bran wax, Oryza sativa bran wax, carnauba wax and aluminum oxide, and poly(hydroxybutyrate-co-hydroxyvalerate).

In one or more embodiments, the mixing is at a weight ratio of the superabsorbent polymer to the hydrophobic material ranging from 100:1 to 1:1000.

In one or more embodiments, the mixing is at a weight ratio of the superabsorbent polymer to the hydrophobic material ranging from 1:50 to 1:200.

Additional Experimentation Follows:

### LP21007 Zeba and SpeedFLOW (Hydrophobic) Ratio

The purpose of this experiment was to try various ratios of Zeba+SpeedFLOW to determine an optimal combination for ensuring the mixture would be flowable without hindering the absorption of water. Samples were made that had various ratios of SpeedFLOW+Zeba. The ratios were as follows:
Zeba by itself
Entry #1=1:30
Entry #2=1:20
Entry #3=1:70

100 g of each of the entries were weighed out into identical containers. These containers were left on the lab bench ambient at approximately 25 C. 20 g of water was added to each container at the same time. The samples were observed:
When water was added side-by-side to Entry #2 and Entry #3, Entry #2 allowed for the water to be poured faster into the sample than Entry #3
When water was added side-by-size to Zeba and Entry #1, Entry #1 seemed so absorb the water faster where as the Zeba had the water bead up on top of the sample

Conclusion: The samples that had SpeedFLOW had the water penetrate deeper into the samples. The samples that had SpeedFLOW also seemed to absorb water slightly faster.

2 g of each of the entries were weighed out into identical containers. These containers were left on the lab bench ambient at approximately 25 C. 100 g of water was added to each container at the same time. The samples were observed:
After 1 minute, the samples were all absorbing water
After 5 minutes, the samples were all a consistency similar to apple sauce
After 8 minutes, the Zeba and Entry #3 samples were a Jell-O consistency, Entry #1 and Entry #2 were the consistency of apple sauce
After 20 minutes, the Zeba and Entry #3 samples were a Jell-O consistency, Entry #1 and Entry #2 were the consistency of apple sauce
After 45 minutes, all of the samples were a similar consistency of Jell-O/apple sauce
After 50 minutes, all of the samples were a similar consistency of Jell-O/apple sauce

Conclusion: The samples that had SpeedFLOW did not hinder the water uptake speed or the amount of water that could be absorbed by the sample.

Samples of each of the entries were put into the freezer and left there for 1.5 days. These samples were taken out of the freezer and 2 g of each of these samples were weighed out into identical containers. These containers were brought into a sealed tent that had been brought up to 99% humidity using a humidifier. 120 g of water was added to each sample at the same time as soon as the samples were brought into the tent. The samples were very hard to see due to how smoky the tent was from the humidifier keeping the tent at that humidity. Due to the difficulty seeing the samples, few photos were taken. However, videos were taken periodically showing the samples being lightly shaken to show the consistency of the samples. The samples were then left in the humid tent for approximately 2 hours and the samples were observed:
After 1 minute all entries were liquid
After 5 minutes Entry #1 was apple sauce, Entries #2 and #3 were watery apple sauce, Zeba was liquid
After 18 minutes Entry #1 was apple sauce, Entries #2 and #3 were watery apple sauce, Zeba was liquid
After 21 minutes Entries 1-3 were apple sauce, Zeba was liquidy but getting the consistency of apple sauce or Jell-O at the bottom
After 28 minutes Entries 1-3 are apple sauce and Zeba is watery apple sauce
After 33 Minutes Entries 1-3 are apple sauce and Zeba is watery apple sauce
After 1 hour 17 minutes all samples were apple sauce
After 2 Hours 8 Minutes all Samples are apple sauce/Jell-O

The samples were then left ambient on the lab bench at approximately 25 C overnight to see if there would be any noticeable changes in the samples. There were no noticeable changes in the samples. They did not appear to change in consistency overnight. There were no temperature changes. The viscosities of the samples after being left on the lab bench overnight were as follows:
Zeba: 3120 cPs
Entry #1 (SpeedFlow:Zeba @ 1:30)=3670 cPs
Entry #2 (SpeedFlow:Zeba @ 1:20)=4560 cPs
Entry #3 (SpeedFlow:Zeba @ 1:70)=3600 cPs

Conclusion: The samples that had SpeedFLOW did not hinder the water uptake speed or the amount of water that could be absorbed by the sample. The samples with more SpeedFLOW seemed to absorb the water slightly faster than the Zeba by itself or the entry with a ratio of 1:70 of SpeedFLOW:Zeba when the samples are taken from a cold environment and then put into a high humidity environment. It is possible that the Zeba clings to itself, hindering water absorption.

1 g of each of the entries were weighed out into identical containers. These were the ambient samples. The containers were brought into a sealed tent that was brought up to 90% humidity. The containers were left in the sealed tent for 1 minute. After 1 minute, 100 g of water was added to each sample at the same time. The samples were brought out of the tent and put onto the lab bench at approximately 25 C. The samples were observed and photographed using the Tagarno microscope auto-photo feature for approximately 1 hour:
After 1 minute all entries were liquid
After 30 minutes, all of the samples were the consistency of apple sauce
After 1 hour, all of the samples were the consistency of apple sauce

Conclusion: The samples that had SpeedFLOW did not hinder the water uptake speed or the amount of water that could be absorbed by the sample. The samples with speedflow seemed to have more even distribution.

Note: The Speedflow did have a tendency to settle out. The product will need to be mixed before application. The product has a tendency to settle during shipping.

What is claimed is:

1. A dry composition for improving the flowability of superabsorbent polymers for use in an agricultural environment, the composition comprising a mixture of a superabsorbent polymer and a hydrophobic material.

2. The dry composition of claim 1, wherein the superabsorbent polymer comprises one or a combination of starch-based polymers, starch-g-poly (2-propenamide-co-2-propenoic acid), xanthan gum, guar gum, hydroxyethylcarboxymethylcellulose, carboxymethylcellulose, polyacrylamides, or, comprises one of Zeolite hyaluronic acid, humic acid, Chitin/chitosan polymers, volcanic earth and ash, kelp and sea weed powders.

3. The dry composition of claim 1, wherein the hydrophobic material comprises one or a combination of i) a protein powder and a lipid, ii) a micronized powder, iii) a micronized wax, iv) fumed silica, and v) treated clay particles.

4. The dry composition of claim 3, wherein the protein powder and the lipid comprise one or a combination of a soy protein powder, a corn protein powder, an oat protein powder, a wheat protein powder, a pea protein powder, a rice protein powder, a nut protein powder, an algal protein powder, a kelp protein powder, a whey protein powder, a casein protein powder, an egg protein powder, an albumen protein powder, a blood meal protein powder, a bone meal protein powder, a fish protein powder, a shellfish protein powder, a plankton protein powder, a yeast protein powder, a bacterial protein powder, a lecithin, a soy lecithin, a vegetable oil, a fish oil, and an animal fat.

5. The dry composition of claim 3, wherein the micronized powder or the micronized wax comprises one or a combination of bran wax, Oryza sativa bran wax, carnauba wax and aluminum oxide, and poly(hydroxybutyrate-co-hydroxyvalerate).

6. The dry composition of claim 1, wherein the mixture is a weight ratio of the superabsorbent polymer to the hydrophobic material ranging from 100:1 to 1:1000.

7. The dry composition of claim 1, wherein the mixture is a weight ratio of the superabsorbent polymer to the hydrophobic material ranging from 1:50 to 1:200.

8. A method for improving the flowability of a dry superabsorbent polymer for use in an agricultural environment, the method comprising mixing a dry superabsorbent polymer with a dry hydrophobic material, wherein the mixing improves the flowability of the dry superabsorbent polymer.

9. The method of claim 8, wherein the superabsorbent polymer comprises one or a combination of starch-based polymers, starch-g-poly (2-propenamide-co-2-propenoic acid), xanthan gum, guar gum, hydroxyethylcarboxymethylcellulose, carboxymethylcellulose, polyacrylamides, and derivatives thereof.

10. The method of claim 8, wherein the hydrophobic material comprises: i) a protein powder and a lipid, ii) a micronized powder, iii) a micronized wax, iv) fumed silica, or v) treated clay particles, and combinations thereof.

11. The method of claim 10, wherein the protein powder and the lipid comprise one or a combination of a soy protein powder, a corn protein powder, an oat protein powder, a wheat protein powder, a pea protein powder, a rice protein powder, a nut protein powder, an algal protein powder, a kelp protein powder, a whey protein powder, a casein protein powder, an egg protein powder, an albumen protein powder, a blood meal protein powder, a bone meal protein powder, a fish protein powder, a shellfish protein powder, a plankton protein powder, a yeast protein powder, a bacterial protein powder, a lecithin, a soy lecithin, a vegetable oil, a fish oil, and an animal fat.

12. The method of claim 10, wherein the micronized powder or micronized wax comprises one or a combination of bran wax, Oryza sativa bran wax, carnauba wax and aluminum oxide, and poly(hydroxybutyrate-co-hydroxyvalerate).

13. The method of claim 10, wherein the mixing is at a weight ratio of the superabsorbent polymer to the hydrophobic material ranging from 100:1 to 1:1000.

14. The method of claim 10, wherein the mixing is at a weight ratio of the superabsorbent polymer to the hydrophobic material ranging from 1:50 to 1:200.
